(19) United States
(12) Patent Application Publication
(10) Pub. No.: US 2025/0286086 A1
(43) Pub. Date: Sep. 11, 2025

(54) METHOD FOR MAKING A SOEC/SOFC-TYPE SOLID OXIDE STACK AND ASSOCIATED STACK

(71) Applicant: COMMISSARIAT À L'ÉNERGIE ATOMIQUE ET AUX ÉNERGIES ALTERNATIVES, Paris (FR)

(72) Inventors: Stéphane Di Iorio, Grenoble (FR); Bruno Oresic, Grenoble (FR)

(21) Appl. No.: 18/558,857

(22) PCT Filed: Apr. 26, 2022
(86) PCT No.: PCT/FR2022/050789

§ 371 Date: Apr. 30, 2024

(30) Foreign Application Priority Data
May 4, 2021 (FR) FR2104688

(51) Int. Cl. H01M 8/0286; C25B 9/77; C25B 13/02; C25B 13/07; H01M 8/021; H01M 8/0217; H01M 8/0228; H01M 8/0247; H01M 8/0284; H01M 8/12; H01M 8/2432

(52) U.S. Cl. CPC H01M 8/0286; C25B 9/77; C25B 13/02; C25B 13/07; H01M 8/021; H01M 8/0217; H01M 8/0228; H01M 8/0247; H01M 8/0284; H01M 8/2432; H01M 2008/1293

(57) ABSTRACT

A main object of the invention is a method for making a SOEC/SOFC-type solid oxide stack operating at high temperature, including a plurality of electrochemical cells each formed by a cathode, an anode and an electrolyte interposed between the cathode and the anode, and a plurality of metal interconnectors each arranged between two adjacent electrochemical cells,
each interconnector having two main planar faces, a first face (P1) of the two main planar faces comprising a metal coating layer (GN) in the form of a grid forming a contact layer with an electrochemical cell,
the method including the step of spot-welding (S) the metal coating layer (GN) on the first face (P1) of the interconnector to enable fastening thereof.

### TECHNICAL FIELD

The present invention relates to the general field of high-temperature electrolysis (HTE) of water, in particular the high-temperature steam electrolysis (HTSE), of the electrolysis of carbon dioxide (CO₂), and also of the co-electrolysis at high temperature (HTE) of water with carbon dioxide (CO₂).

More specifically, the invention relates to the field of high-temperature solid-oxide electrolysers, usually referred to by the acronym SOEC (standing for “Solid-Oxide Electrolyser Cell”).

It also relates to the field of high-temperature solid-oxide fuel cells, usually referred to by the acronym SOFC (standing for “Solid-Oxide Fuel Cells”).

Thus, more generally, the invention relates to the field of SOEC/SOFC-type solid-oxide stacks operating at high temperature.

More specifically, the invention relates to a method for making or assembling a SOEC/SOFC-type solid-oxide stack comprising a step of spot-welding on a face of each interconnector of the stack for fastening a contact layer, as well as an associated stack.

### PRIOR ART

In the context of a high-temperature SOEC-type solid-oxide electrolyser, the process consists in transforming, by means of an electric current, within the same electrochemical device, steam (H₂O) into dihydrogen (H₂) and dioxygen (O₂), and/or transforming carbon dioxide (CO₂) into carbon monoxide (CO) and dioxygen (O₂). In the context of a high-temperature SOFC-type solid-oxide fuel cell, the operation is reversed to produce an electric current and heat by being supplied with dihydrogen (H₂) and dioxygen (O₂), typically with air and natural gas, namely methane (CH₄). For simplicity, the following description favours the operation of a high-temperature SOEC-type solid-oxide electrolyser carrying out the electrolysis of water. Nonetheless, this operation is applicable to the electrolysis of carbon dioxide (CO₂), or to the co-electrolysis at high temperature (HTE) of water with carbon dioxide (CO₂). In addition, this operation can be transposed to the case of a high-temperature SOFC-type solid-oxide fuel cell.

To carry out water electrolysis, it is advantageous to carry it out at high temperature, typically between 600 and 1,000° C., because it is more advantageous to electrolyse steam than liquid water and because part of the energy necessary for the reaction may be supplied by heat, less expensive than electricity.

To implement the high-temperature electrolysis (HTE) of water, a high-temperature SOEC-type solid-oxide electrolyser consists of a stack of elementary patterns each including a solid-oxide electrolysis cell, or an electrochemical cell, consisting of three anode/electrolyte/cathode layers superposed on top of one another, and of interconnection plates often made of metal alloys, also called bipolar plates or interconnectors. Each electrochemical cell is sandwiched between two interconnection plates. A high-temperature SOEC-type solid-oxide electrolyser is then an alternating stack of electrochemical cells and interconnectors. A high-temperature SOFC-type solid-oxide fuel cell consists of the same type of stack of elementary patterns. This high-temperature technology being reversible, the same stack can operate in electrolysis mode and produce hydrogen and oxygen from water and electricity, or in fuel cell mode and produce electricity from hydrogen and oxygen.

Each electrochemical cell corresponds to an electrolyte/electrode assembly, which is typically a multilayer ceramic assembly the electrolyte of which is formed by an ion-conducting central layer, this layer being solid, dense and sealed, and sandwiched between the two porous layers forming the electrodes. It should be noted that additional layers may exist, but which serve only to improve one or more of the already described layers.

The electrical and fluidic interconnection devices consist of electronic conductors which ensure, from an electrical point of view, the connection of each electrochemical cell with an elementary pattern in the stack of elementary patterns, guaranteeing electrical contact between one face and the cathode of a cell and between the other face and the anode of the next cell, and from a fluidic point of view, thereby combining the production of each of the cells. Thus, the interconnectors ensure the functions of supplying and collecting electric current and delimit gas circulation compartments, for distribution and/or collection.

More specifically, the main function of the interconnectors is to ensure the passage of the electric current but also the circulation of the gases in the vicinity of each cell (namely: injected steam, hydrogen and oxygen extracted for the HTE electrolysis; air and fuel including the injected hydrogen and extracted water for a SOFC cell), and to separate the anode and cathode compartments of two adjacent cells, which are the gas circulation compartments on the side respectively of the anodes and cathodes of the cells.

In particular, for a high-temperature SOEC-type solid-oxide electrolyser, the cathode compartment includes steam and hydrogen, produced from the electrochemical reaction, whereas the anode compartment includes a draining gas, if present, and oxygen, another product of the electrochemical reaction. For a high-temperature SOFC-type solid-oxide fuel cell, the anode compartment includes the fuel, whereas the cathode compartment includes the oxidiser.

In order to carry out the high-temperature steam electrolysis (HTE), steam (H₂O) is injected into the cathode compartment. Under the effect of the electric current applied to the cell, the dissociation of the water molecules in the form of steam is carried out at the interface between the hydrogen electrode (cathode) and the electrolyte: this dissociation produces dihydrogen gas (H₂) and oxygen ions (O²⁻). The dihydrogen (H₂) is collected and discharged at the hydrogen compartment outlet. The oxygen ions (O²⁻) migrate through the electrolyte and recombine with dioxygen (O₂) at the interface between the electrolyte and the oxygen electrode (anode). A draining gas, such as air, can circulate at the anode and thus collect the oxygen generated in gaseous form at the anode. To ensure the operation of a solid-oxide fuel cell (SOFC), air (oxygen) is injected into the cathode compartment of the cell and hydrogen in the anode compartment. The oxygen of the air will dissociate into O²⁻ ions. These ions will migrate into the electrolyte of the cathode towards the anode to oxidise the hydrogen and form water with a simultaneous production of electricity. In SOFC cell, as well as in SOEC electrolysis, the steam is in the dihydrogen compartment (H₂). Only the polarity is reversed.

For illustration, FIG. 1 shows a schematic view showing the operating principle of a high-temperature SOEC-type solid-oxide electrolyser. The function of such an electrolyser is to transform the steam into hydrogen and oxygen according to the following electrochemical reaction:

2 H₂O→2 H₂+O₂.

This reaction is carried out electrochemically in the cells of the electrolyser. As schematised in FIG. 1, each elementary electrolysis cell 1 is formed by a cathode 2 and an anode 4, placed on either side of a solid electrolyte 3. The two electrodes (cathode and anode) 2 and 4 are electronic and/or ionic conductors, made of porous material, and the electrolyte 3 is gas-tight, electronic insulator and ionic conductor. In particular, the electrolyte 3 may be an anionic conductor, more specifically an anionic conductor of the O²⁻ ions and the electrolyser is then referred to as an anionic electrolyser, in contrast with proton electrolytes (H⁺).

The electrochemical reactions take place at the interface between each of the electronic conductors and the ionic conductor.

At the cathode 2, the half-reaction is as follows:

2 H₂O+4 e⁻→2 H₂+2 O²⁻.

At the anode 4, the half-reaction is as follows:

2 O²⁻→O₂+4 e⁻.

The electrolyte 3, interposed between the two electrodes 2 and 4, is the site of migration of the ions O²⁻ under the effect of the electric field created by the potential difference imposed between the anode 4 and the cathode 2.

As illustrated in parentheses in FIG. 1, the steam at the cathode inlet may be accompanied by hydrogen H₂ and the hydrogen produced and recovered at the outlet may be accompanied by steam. Similarly, as illustrated in dotted lines, a draining gas, such as air, may also be injected at the inlet to discharge the produced oxygen. The injection of a draining gas has the additional function of acting as a thermal regulator.

An elementary electrolyser, or electrolysis reactor, consists of an elementary cell as described hereinabove, with a cathode 2, an electrolyte 3, and an anode 4, and two interconnectors which ensure the electrical, hydraulic and thermal distribution functions.

To increase the flow rates of produced hydrogen and oxygen, it is known to stack several elementary electrolysis cells on top of one another while separating them by interconnectors. The assembly is positioned between two end interconnection plates which support the electric power supplies and gas supplies of the electrolyser (electrolysis reactor).

Thus, a high-temperature SOEC-type solid-oxide electrolyser comprises at least one, generally a plurality of electrolysis cells stacked on top of one another, each elementary cell being formed of an electrolyte, a cathode and an anode, the electrolyte being interposed between the anode and the cathode.

As indicated before, the fluidic and electrical interconnection devices which are in electrical contact with one or more electrode(s) generally ensure the functions of supplying and collecting electric current and delimit one or more gas circulation compartment(s).

Thus, the function of the so-called cathode compartment is the distribution of the electric current and of the steam as well as the recovery of hydrogen at the cathode in contact.

The function of the so-called anode compartment consists in the distribution of the electric current as well as the recovery of the oxygen produced at the anode in contact, possibly using a draining gas.

FIG. 2 shows an exploded view of elementary patterns of a high-temperature SOEC-type solid-oxide electrolyser according to the prior art. This electrolyser includes a plurality of elementary electrolysis cells C1, C2, of solid oxide type (SOEC), alternately stacked with interconnectors 5. Each cell C1, C2 consists of a cathode 2.1, 2.2 and of an anode (only the anode 4.2 of the cell C2 is shown), between which an electrolyte (only the electrolyte 3.2 of the cell C2 is shown).

The interconnector 5 is typically a component made of a metal alloy that ensures the separation between the cathode 50 and anode 51 compartments, defined by the volumes comprised between the interconnector 5 and the adjacent cathode 2.1 and between the interconnector 5 and the adjacent anode 4.2, respectively. It also ensures the distribution of the gases to the cells. The injection of steam into each elementary pattern is done in the cathode compartment 50. The collection of the produced hydrogen and of the residual steam at the cathode 2.1, 2.2 is performed in the cathode compartment 50 downstream of the cell C1, C2 after dissociation of the steam by the latter. The collection of the oxygen produced at the anode 4.2 is performed in the anode compartment 51 downstream of the cell C1, C2 after dissociation of the steam by the latter. The interconnector 5 ensures the passage of the current between the cells C1 and C2 by direct contact with the adjacent electrodes, i.e. between the anode 4.2 and the cathode 2.1.

The operating conditions of a high-temperature solid-oxide electrolyser (SOEC) being very close to those of a solid-oxide fuel cell (SOFC), the same technological constraints are found.

Thus, the proper operation of such SOEC/SOFC-type solid-oxide stacks operating at high temperature primarily requires addressing the points set out hereinafter.

First of all, it is necessary to have an electrical insulation between two successive interconnectors otherwise there would be short-circuiting of the electrochemical cell, but also a good electrical contact and a sufficient contact surface between a cell and an interconnector. The lowest possible ohmic resistance is desired between the cells and the interconnectors.

Moreover, it is necessary to have sealing between the anode and cathode compartments otherwise there would be a recombination of the produced gases resulting in a decrease in yield and above all the apparition of hot spots damaging the stack.

Finally, it is essential to have a good distribution of the gases both at the inlet and at the recovery of the products otherwise there would be a loss of yield, a pressure and temperature inhomogeneity within the different elementary patterns, and possibly prohibitive degradations of the electrochemical cells.

To achieve an increase in the production efficiency and to obtain a good homogeneity of operation of SOEC/SOFC-type solid-oxide stacks operating at high temperature, the role of the interconnectors is essential, in particular to obtain good electrical contacts between the different portions of the stacks and also enable a good distribution of the gases within the electrochemical cells. The interconnectors may be metallic and composed of three thin plates, or also called sheet metals or strips, welded together, as described in the French patent application FR 3 024 985 A1.

Thus, FIG. 3 shows, according to an exploded view, an example of an interconnector 5 formed by the assembly of three thin sheet metals 21 to 23, assembled and laminated.

The three sheet metals 21, 22, 23 are elongated according to two axes of symmetry X and Y orthogonal to each other, the sheet metals being laminated and assembled together by welding. A central sheet metal 22 is interposed between a first end sheet metal 21 and a second end sheet metal 23.

The central sheet metal 22 herein includes a stamped central portion 70 defining raised, or stamped, elements 10. Alternatively, the central sheet metal 22, and therefore the central portion 70, may be smooth. In addition, it is pierced at the periphery of its central portion 70, with four apertures 71, 72, 73, 74. By “aperture”, it should be understood a hole opening on either side of a metal sheet metal.

One of the end planar sheet metals 21 includes a planar central portion 69 and is pierced, at the periphery of its central portion 69, with four apertures 61, 62, 63, 64. The first end sheet metal 21 further includes two slots 67, 68, apertures arranged symmetrically on either side of the axis Y. They are elongated over a length corresponding substantially to the length of the central portion 69 according to the axis Y.

The other one amongst the end planar sheet metals 23 includes a recessed and pierced central portion 89, at the periphery of its central portion 89, with four apertures 81, 82, 83, 84.

The apertures 61, 71, 81, 63, 73, 83 of each sheet metal are elongated over a length corresponding substantially to the length of the central portion 69, 70, 89 along the axis X, whereas the apertures 62, 72, 82, 64, 74, 84 of each sheet metal are elongated over a length corresponding substantially to the length of the central portion 69, 70, 89 according to the axis Y.

The apertures 71 to 74 of the central sheet metal 22 are widened respectively with respect to the apertures 61, 81, 62, 82, 63, 83, 64, 84, and they include in their widened portion sheet metal tabs 710, 720, 730, 740 spaced apart from one another forming a comb. Each of the slots 711, defined between the edge of the enlarged aperture 71 and a tab 710 or between two successive tabs 710 opens onto the channels 11 defined by the reliefs 10 or stamped. The same applies to the slots made on the side of the apertures 72, 73, 74.

The sheet metals 21, 22, 23 are typically made of ferritic steel with about 20% chromium, preferably CROFER® 22 (APU or H) or K41 (ASI 441) or FT18TNb, based on Nickel of the Inconel @ 600 or Haynes® type with thicknesses typically comprised between 0.1 and 1 mm.

These interconnectors may also be described in the French patent application FR 2 996 065 A1. In this application, the interconnector corresponds to a component with a substrate made of a metal alloy, the base element of which is Iron (Fe) or Nickel (Ni), with one of the main planar faces coated with a thick ceramic layer, grooved while delimiting channels suited for the distribution and/or collection of gases, such as steam H₂O, H₂; Air, and the other one amongst the main planar faces coated with a thick metal layer, grooved while delimiting channels suited for the distribution and/or collection of gases, such as steam H₂O, H₂; O₂, draining gas. In particular, a thick ceramic contact layer based on strontium-doped lanthanum manganite may be provided on the side of the oxygen electrode (EHT anode, cathode for a SOFC cell), on the end sheet metal 23, which is heat-pressed according to the principle of FR 2 996 065 A1, and a nickel-based thick metal contact layer may be provided on the side of the hydrogen electrode (cathode in HTE, anode for a SOFC cell), on the end sheet metal 21, and be in particular in the form of a Nickel grid.

By “thick layer”, it should be understood a layer, whose thickness is larger than that of a layer obtained by a so-called “thin layer” technology, typically a thickness comprised between 2 and 15 μm. Thus, good performances are obtained with good homogeneity in SOFC/SOEC-type solid-oxide stacks with low production costs.

The manufacture and assembly of the stack, namely all of the electrochemical cells 1 and of the interconnectors 5, is done in a particular way taking into account the geometry of the plates and the design technical choices made. In particular, a stack of successive layers is made with the following sequence: interconnector, then ceramic contact layer, then electrochemical cell, then metal contact layer, then interconnector, etc.

Also, there are still needs to optimise stacking of such successive layers to form the stack, and in particular to obtain a secured assembly so as to avoid any movement during the assembly and stacking phases enabling manufacturing of the stack.

### DISCLOSURE OF THE INVENTION

The invention aims to at least partially address the aforementioned need and the drawbacks related to the embodiments of the prior art.

In particular, it aims to make an interconnector/contact layer/electrochemical cell assembly for SOEC/SOFC-type solid-oxide stacks which is stable and secured to facilitate the manufacture of the stack.

Thus, an object of the invention is, according to one of its aspects, a method for making a SOEC/SOFC-type solid-oxide stack operating at high temperature, including a plurality of electrochemical cells each formed by a cathode, an anode and an electrolyte interposed between the cathode and the anode, and a plurality of metal interconnectors each arranged between two adjacent electrochemical cells,
each interconnector having two main planar faces, a first face of the two main planar faces comprising a metal coating layer in the form of a grid forming a contact layer with an electrochemical cell,
the method including the step of spot-welding the metal coating layer on the first face of the interconnector to enable fastening thereof.

The making method according to the invention may further include one or more of the following features considered separately or in any technically-feasible combination.

The metal material of the coating layer may be selected from among Nickel and its alloys, the coating layer being in particular in the form of a Nickel grid, or chromia-forming alloys whose base element is Iron.

Furthermore, several welding spots may be made, in particular at least four, and possibly at least eight, by being evenly distributed at the periphery of the coating layer, being in particular present at the angles of the coating layer.

In addition, the making method may advantageously include the step of depositing a glue over the coating layer intended to fasten the electrochemical cell. Advantageously, the glue may comprise between 5% and 50% by weight of polyvinyl butyral (PVB), between 5% and 50% by weight of terpineol and between 5% and 95% by weight of ethanol.

The glue may be deposited at the periphery of the coating layer, in particular off the active area and at a distance from the gas supplies.

Moreover, the making method may include the step of depositing a glass layer over the coating layer before the glue deposition step.

In addition, each interconnector having two main planar faces, a second face of the main planar faces may comprise a thick coating layer made of ceramic, forming a contact layer with an electrochemical cell, the ceramic material being selected in particular from among a strontium-doped lanthanum manganite of formula La₁₋ₓSrₓMO₃ with M (transition metals)=Nickel, Iron, Cobalt, Manganese, Chromium, alone or as a mixture, or materials with a lamellar structure such as the lanthanide nickelates of formula Ln₂NiO₄ (Ln=Lanthanum, Neodymium, Praseodymium), or another electrically-conductive perovskite oxide.

Furthermore, each interconnector may be formed by the assembly of at least three elongated plates according to a first axis of symmetry and a second axis of symmetry orthogonal to each other, a central plate being interposed between a first end plate and a second end plate.

Moreover, another object of the invention is, according to another one of its aspects, a SOEC/SOFC-type solid-oxide stack operating at high temperature, obtained by means of a making method as defined before, including a plurality of electrochemical cells each formed by a cathode, an anode and an electrolyte interposed between the cathode and the anode, and a plurality of metal interconnectors each arranged between two adjacent electrochemical cells.

### BRIEF DESCRIPTION OF THE DRAWINGS

The invention could be better understood upon reading the following detailed description, of non-limiting examples of implementation thereof, as well as upon examining the figures, schematic and partial, of the appended drawing, wherein:

FIG. 1 is a schematic view showing the operating principle of a high-temperature solid-oxide electrolyser (SOEC),

FIG. 2 is an exploded schematic view of a portion of a high-temperature solid-oxide electrolyser (SOEC) comprising interconnectors according to the prior art,

FIG. 3 is an exploded view of an interconnector for a high-temperature SOEC/SOFC-type solid oxide stack, corresponding to the assembly of three thin sheet metals or plates,

FIG. 4 is a partial front view of an interconnector sheet metal for a high-temperature SOEC/SOFC-type solid oxide stack illustrating the spot-welding step of the making method in accordance with the invention,

FIG. 5 illustrates in a graphic form the thermogravimetric analysis (TGA) of the glue of the making method in accordance with the invention under different atmospheres,

FIGS. 7 and 8 are two partial front views of the interconnector sheet metal of FIG. 4 illustrating the glue deposition step of the making method in accordance with the invention,

FIG. 8 is a partial front view of the sheet metal of the interconnector of FIG. 4 illustrating the step of gluing the electrochemical cell after deposition of the glue illustrated in FIGS. 6 and 7, and

FIG. 9 shows, in perspective and by observation from above, a set comprising a SOEC/SOFC-type solid oxide stack with a stack of electrochemical cells and of interconnectors obtained by the making method in accordance with the invention, and a system for clamping the stack.

In all these figures, identical references could designate identical or similar elements.

In addition, the different portions shown in the figures are not necessarily plotted according to a uniform scale, to make the figures more readable.

### DETAILED DISCLOSURE OF PARTICULAR EMBODIMENTS

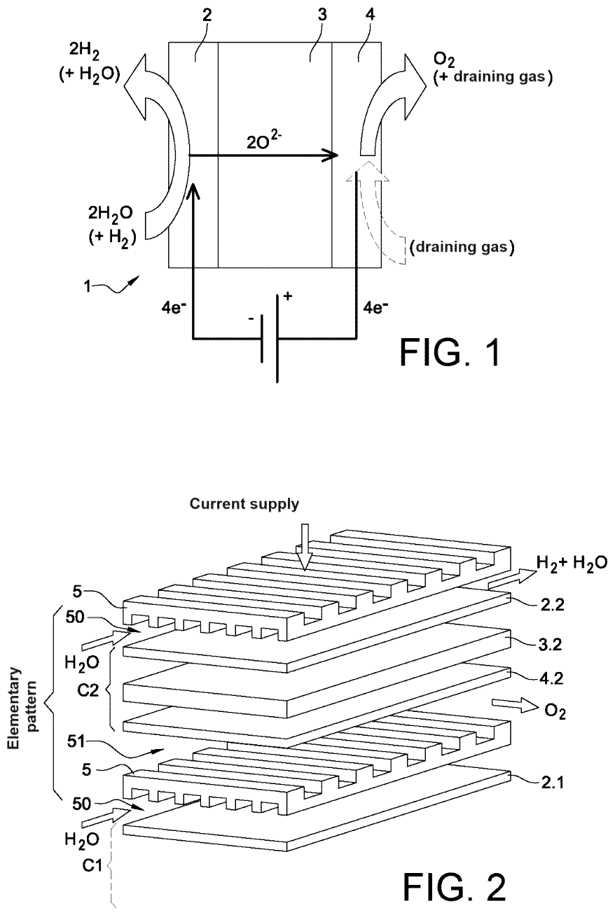

FIGS. 1 to 3 have already been described before in the part relating to the prior art and to the technical context of the invention. It is specified that, for FIGS. 1 and 2, the symbols and arrows of the steam H₂O supply, dihydrogen H₂, oxygen O₂, air distribution and recovery and electric current, are shown for clarity and accuracy, to illustrate the operation of the illustrated devices.

Furthermore, it should be noted that all of the constituents (anode/electrolyte/cathode) of a given electrochemical cell are preferably ceramics. Moreover, the operating temperature of a high-temperature SOEC/SOFC-type stack is typically comprised between 600 and 1,000° C.

In addition, the possible terms “upper” and “lower” should herein be understood according to the normal orientation of a SOEC/SOFC-type stack when in its use configuration.

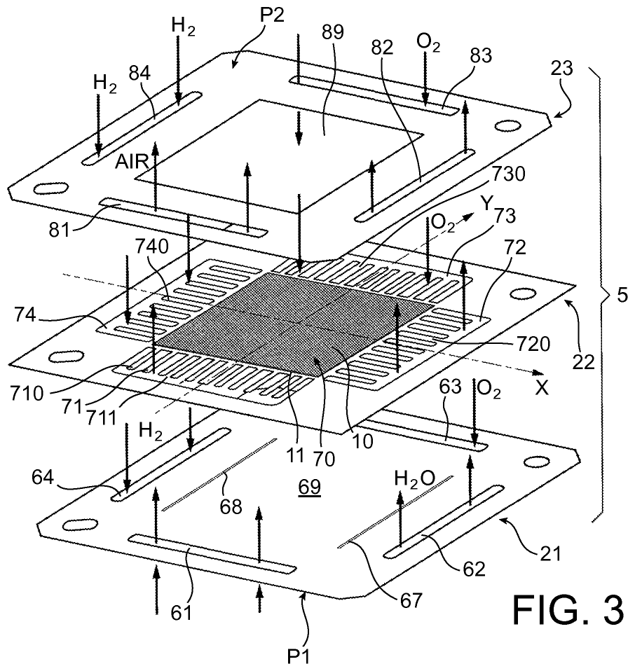

FIG. 3 previously described relates to an interconnector 5 formed by the assembly of three metal thin sheet metals 21 to 23.

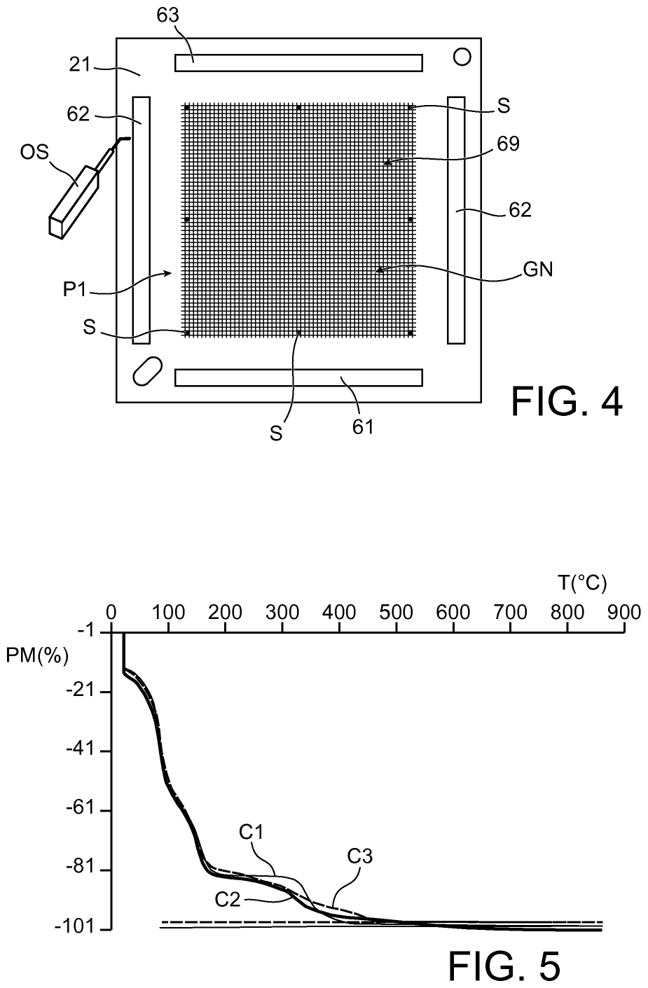

The making method in accordance with the invention will be described with reference to FIGS. 4 to 8, FIGS. 4 and 6 to 8 partially showing the sheet metal 21 of the interconnector 5 of FIG. 3. Also, elements that have already been described will not be described again.

It should be noted that the interconnector 5 may include a substrate made of a metal alloy, in particular of the chromia-forming type, the base element of which is Iron (Fe) or Nickel (Ni), having two main planar faces P1 and P2, as described in the French patent application FR 2 996 065 A1.

Thus, as shown in FIG. 3, the interconnector 5 has two main planar faces P1 and P2. The first main planar face P1 is intended to be covered by a metal coating layer GN, visible in FIG. 4, forming a contact layer with an electrochemical cell 1, and provided in particular on the side of the hydrogen electrode. Preferably, the material of this metal coating layer GN is selected from among Nickel and its alloys or chromia-forming alloys, the base element of which is iron Fe. In particular, this metal coating layer GN is in the form of a Nickel grid, as shown in FIGS. 4, 6 and 7.

The making method in accordance with the invention aims to enable an optimum assembly between the interconnector 5 and the electrochemical cell 1, and in particular between the end sheet metal 21 and the Nickel grid GN.

Thus, the method includes the step of spot-welding S the metal coating layer GN on the first face P1 of the interconnector 5 to enable fastening thereof. As shown in FIG. 4, this welding is carried out using a welding tool OS, in particular a spot-welding device.

The Nickel grid GN is positioned over the central portion 69 of the end sheet metal 21, the apertures 62 and 63 of which are visible in FIG. 4, and welding spots S are made all around the periphery of the Nickel grid GN to enable fastening thereof to the first main planar face P1.

In particular herein, eight welding spots S are made in the peripheral area of the Nickel grid GN, namely four welding spots S at the four corners of the Nickel grid GN and four spots on the media on each side of the Nickel grid GN. These welding spots S are evenly spaced apart at the periphery of the Nickel grid GN. It is possible to have a larger number of welding spots S but this lengthens the duration of this step of the making method.

Advantageously, this spot welding allows holding the Nickel grid GN in place without deforming it and without supplying a filler element so as to limit any pollution, unlike the solutions of the prior art which do not provide for any means for fastening the Nickel grid GN to the end sheet metal 21.

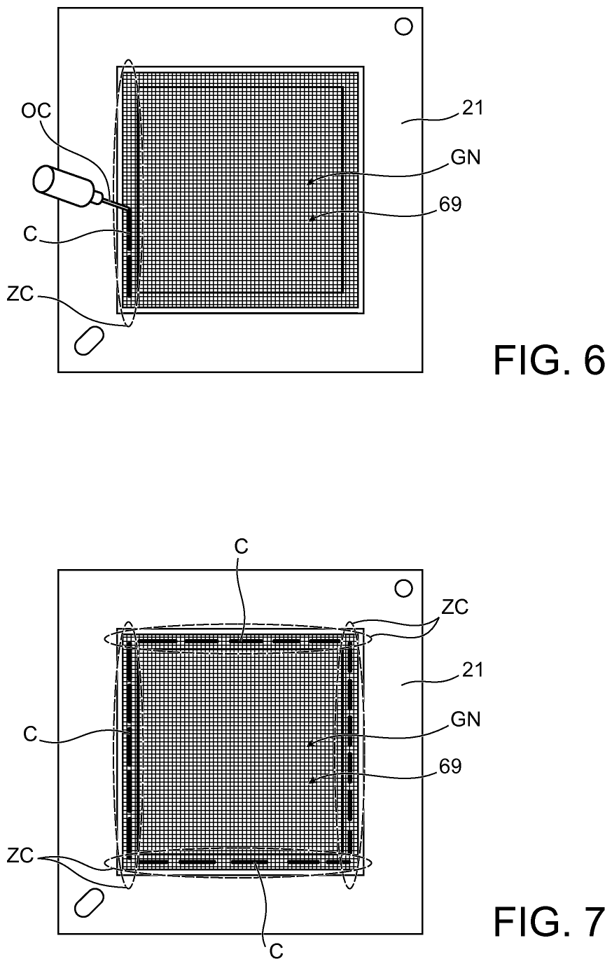

Moreover, as illustrated in FIGS. 6 and 7, the making method in accordance with the invention includes a step of depositing a glue C over the Nickel grid GN to prepare it to receive the electrochemical cell 1 and to enable optimum fastening of the electrochemical cell 1 on the interconnector 5 via the contact layer formed by the Nickel grid GN.

The used glue C, or adhesive, includes a composition that is very accurate in order to enable an optimised fastening to the Nickel grid GN and not to leave residue during passage to high temperature.

In particular, the glue C includes between 5% and 50% by weight of polyvinyl butyral (PVB), between 5% and 50% by weight of terpineol and between 5% and 95% by weight of ethanol. Preferably, the glue C includes 17% by weight of polyvinyl butyral (PVB), 28% by weight of terpineol and between 55% by weight of ethanol. Thus, the composition of the glue C may vary but the viscosity of the glue C will evolve with the mixing ratios.

The advantage of such a gluing step is to avoid the movement of the electrochemical cell 1 during the next phases of making of the stack, or assembly, but also to re-flatten the electrochemical cell 1 for the frequent case where it is curved. Moreover, the specific composition of the proposed glue C allows avoiding the drawbacks of a conventional glue which would leave residues after heating, thereby creating pollutions detrimental to the durability of the SOFC/SOEC stack.

FIG. 7 is a graph illustrating the evolution of the mass loss PM, expressed as a percentage (%), as a function of the temperature T, expressed in degrees Celsius (° C.). Thus, this consists of a thermogravimetric analysis (TGA) of the glue C. Three curves C1, C2 and C3 are shown, corresponding to three different atmospheres. Thus, one could notice that, irrespective of the atmosphere, no mass residue is obtained beyond 500° C. Thus, the used glue C with a specific composition enables the absence of residue after heating.

Advantageously, the glue C is deposited at the periphery of the Nickel grid GN, off the active area and at a distance from the gas supplies. As shown in FIGS. 6 and 7, the glue C is thus arranged, by means of a glue deposition tool OC, in peripheral glue deposition areas ZC in order to avoid clogging any gas circulation.

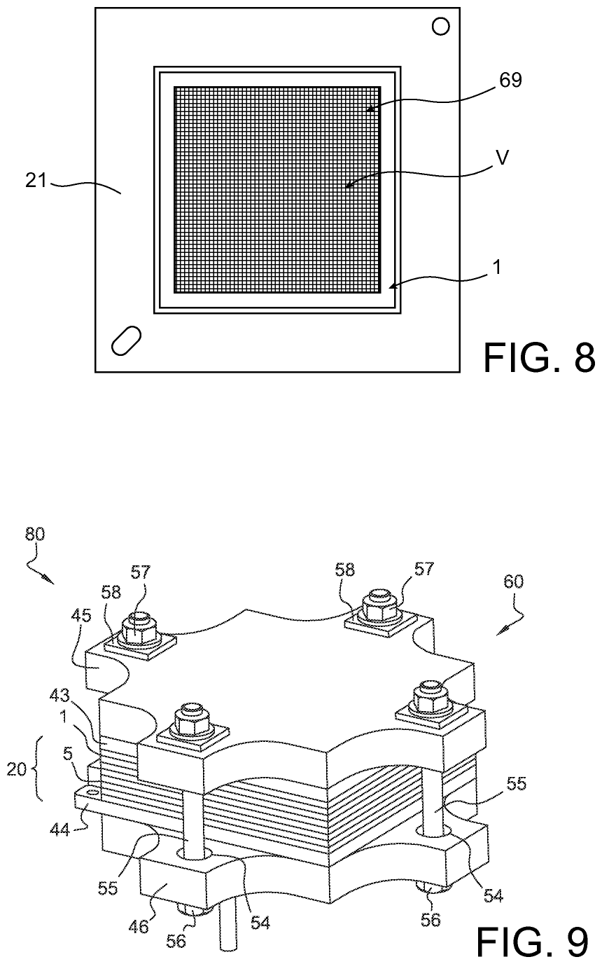

Once the glue C has been deposited, the electrochemical cell 1 is put in place, as illustrated in FIG. 8, and a load is positioned for a few hours so that the glue C could dry and in order to hold the electrochemical cell 1 even though it were initially deformed.

Nonetheless, prior to the deposition of the glue C, the making method in accordance with the invention may comprise the step of depositing a glass layer V, visible in FIG. 8, over the Nickel grid GN. This deposition of glass V allows increasing the fluid distribution, as described in the French patent application FR 3 056 337 A1. In addition, carrying out gluing following the deposition of glass V allows having a glass layer V which is even more flexible because it is not completely dry. It should also be noted that, as shown in FIG. 3, the interconnector 5 has a second face P2 which comprises a thick ceramic coating layer, provided in particular on the side of the oxygen electrode, forming a contact layer with an electrochemical cell 1. The ceramic material may be selected from among a strontium-doped lanthanum manganite of formula La₁₋ₓSrₓMO₃ with M (transition metals)=Nickel (Ni), Iron (Fe), Cobalt (Co), Manganese (Mn), Chromium (Cr), alone or as a mixture, or materials with a lamellar structure such as the lanthanide nickelates of formula Ln₂NiO₄ (Ln=Lanthanum (La), Neodymium (Nd), Praseodymium (Pr)), or another electrically-conductive perovskite oxide.

The different steps of the making method in accordance with the invention are repeated for all interconnectors 5 and electrochemical cells 1 so as to obtain a SOEC/SOFC-type solid-oxide stack 20 operating at high temperature.

FIG. 9 shows such a SOEC/SOFC-type solid oxide stack 20 operating at high temperature in accordance with the invention.

More specifically, FIG. 9 shows a set 80 comprising the SOEC/SOFC-type solid-oxide stack 20 and a clamping system 60.

This set 80 has a structure similar to that of the assembly described in the French patent application FR 3 045 215 A1.

The stack 20 includes a plurality of electrochemical cells 1 each formed of a cathode, an anode and an electrolyte interposed between the cathode and the anode, and a plurality of metal interconnectors 5 each arranged between two adjacent electrochemical cells 1. This set of electrochemical cells 1 and of interconnectors 5 is referred to as “stack”, and is obtained by the previously-described making method in accordance with the invention.

In addition, the stack 20 includes an upper end plate 43 and a lower end plate 44, respectively also referred to as upper stack end plate 43 and lower stack end plate 44, between which the plurality of electrochemical cells 1 and the plurality of interconnectors 5 are clamped, or between which the stack is located.

Moreover, the set 80 also comprises a system 60 for clamping the SOEC/SOFC-type solid-oxide stack 20, including an upper clamping plate 45 and a lower clamping plate 46, between which the SOEC/SOFC-type solid-oxide stack 20 is clamped.

Each clamping plate 45, 46 of the clamping system 60 includes four clamping orifices 54. In addition, the clamping system 60 further includes four clamping rods 55, or tie rods, extending throughout a clamping orifice 54 of the upper clamping plate 45 and throughout a corresponding clamping orifice 54 of the lower clamping plate 46 to enable the assembly of the upper 45 and lower 46 clamping plates. In addition, the clamping system 60 includes clamping means 56, 57, 58 at each clamping orifice 54 of the upper 45 and lower 46 clamping plates cooperating with the clamping rods 55 to enable the assembly of the upper 45 and lower 46 clamping plates. More specifically, the clamping means include, at each clamping orifice 54 of the upper clamping plate 45, a first clamping nut 56 cooperating with the corresponding clamping rod 55 inserted throughout the clamping orifice 54. In addition, the clamping means include, at each clamping orifice 54 of the lower clamping plate 46, a second clamping nut 57 associated with a clamping washer 58, these cooperating with the corresponding clamping rod 55 inserted throughout the clamping orifice 54. The clamping washer 58 is located between the second clamping nut 57 and the lower clamping plate 46.

Of course, the invention is not limited to the embodiments that have just been described. Various modifications may be made thereto by a person skilled in the art.

What is claimed is:

1. A method for making a SOEC/SOFC-type solid oxide stack operating at high temperature, including a plurality of electrochemical cells each formed of a cathode, an anode and an electrolyte interposed between the cathode and the anode, and a plurality of metal interconnectors each arranged between two adjacent electrochemical cells,
each interconnector having two main planar faces, a first face of the two main planar faces comprising a metal coating layer in the form of a grid forming a contact layer with an electrochemical cell,
the method including the step of spot-welding the metal coating layer on the first face of the interconnector to enable fastening thereof,
and the step of depositing a glue at the periphery of the coating layer, off the active area and at a distance from the gas supplies, intended to fasten the electrochemical cell, the glue comprising between 5% and 50% by weight of polyvinyl butyral (PVB), between 5% and 50% by weight of terpineol and between 5% and 95% by weight of ethanol.

2. The method according to claim 1, wherein the metallic material of the coating layer is selected from among nickel (Ni) and its alloys, the coating layer being in particular in the form of a Nickel grid, or the chromia-forming alloys whose base element is Iron (Fe).

3. The method according to claim 1, wherein several welding spots are made, in particular at least four, and possibly at least eight, by being evenly distributed at the periphery of the coating layer, being in particular present at the angles of the coating layer.

4. The method according to claim 1, wherein it includes the step of depositing a glass layer over the coating layer before the glue deposition step.

5. The method according to claim 1, wherein each interconnector having two main planar faces, a second face of the main planar faces comprises a thick ceramic coating layer, forming a contact layer with an electrochemical cell, the ceramic material being selected in particular from a strontium-doped lanthanum manganite of formula La₁₋ₓSrₓMO₃ with M (transition metals)=Nickel (Ni), Iron (Fe), Cobalt (Co), Manganese (Mn), Chromium (Cr), alone or as a mixture, or lamellar structure materials such as lanthanide nickelates of formula Ln₂NiO₄ (Ln=Lanthanum (La), Neodymium (Nd), Praseodymium (Pr)), or another electrically-conductive perovskite oxide.

6. The method according to claim 1, wherein each interconnector is formed by the assembly of at least three plates elongated according to a first axis of symmetry and a second axis of symmetry orthogonal to each other, a central plate being interposed between a first end plate and a second end plate.
